(19) United States
(12) Patent Application Publication
(10) Pub. No.: US 2025/0175734 A1
(43) Pub. Date: May 29, 2025

(54) Method for Outputting an Acoustic Signal in an Interior of a Motor Vehicle, Computer Program, Data Processing Device and Motor Vehicle

(71) Applicant: Bayerische Motoren Werke Aktiengesellschaft, Muenchen (DE)

(72) Inventors: Daniel Schock, Muenchen (DE); Sid Tossenberger, Muenchen (DE); Kevin Matros, Ottobrunn (DE)

(21) Appl. No.: 18/842,757

(22) PCT Filed: Jun. 26, 2023
(86) PCT No.: PCT/EP2023/067243

§ 371 Date: Aug. 29, 2024

(30) Foreign Application Priority Data
Jul. 1, 2022 (DE) 10 2022 116 522.1

(51) Int. Cl. H04R 1/22; B60Q 9/00

(52) U.S. Cl. CPC H04R 1/22; B60Q 9/00; H04R 2499/13

(57) ABSTRACT

A method for outputting an acoustic signal in an interior of a motor vehicle using an interior loudspeaker includes determining the acoustic signal to be output. The method further includes acquiring situation information relating to operating the motor vehicle, and determining signal information relating to the acoustic signal. The acoustic signal is adapted based at least in part on the situation information and the signal information. The adapted acoustic signal is output via the interior loudspeaker.

The present application is the U.S. national phase of PCT Application PCT/EP2023/067243 filed on Jun. 26, 2023, which claims priority of German patent application No. 10 2022 116 522.1 filed on Jul. 1, 2022, the entire contents of which are incorporated herein by reference.

### TECHNICAL FIELD

The present disclosure relates to a method for outputting an acoustic signal in an interior of a motor vehicle using an interior loudspeaker, and to a data processing device designed to perform at least part of the method.

### BACKGROUND

To increase driving pleasure and emotionalization, sounds, e.g. artificially generated drive sounds, are reproduced in motor vehicles via internal loudspeakers. The artificial generation of acoustic outputs is referred to as electric sound design (ESD). By way of example, this can involve sounds of an electric motor vehicle drive being attenuated and other sounds being output instead.

The adaptation of acoustic signals from a motor vehicle is known from the prior art.

US 2020/0324697 A1 discloses a vehicle engine noise control system. The vehicle engine noise control system identifies a vehicle driver by way of a driver smartphone or a sensor for acquiring biometric information of the driver and analyzes the music that the identified driver listens to with the driver smartphone or a vehicle infotainment system. A driving pattern of the driver is analyzed with regard to the vehicle, a GPS position, a road and the weather as conditions. A driver engine noise pattern is generated as a result value. The result value is taken as a basis for adapting and outputting the engine sound.

In the exterior, that is to say, in surroundings of the motor vehicle, loudspeakers are used to protect pedestrians and, in the case of electrified vehicles, for example, to driving increase pleasure and emotionalization for locking and unlocking sounds and/or greeting sounds. Such stagings afford, besides possible information content, the potential to increase pleasure in the product and at the same time to acoustically embody a brand of the motor vehicle, for example.

CN 109878412 A discloses adapting the volume of a horn of a motor vehicle in consideration of urban surroundings.

CN 110588505 A discloses a method for controlling warning tones for a motor vehicle for warning pedestrians in the surroundings of the motor vehicle. A current time of day is determined and a volume can have two modes: a day mode and a night mode.

DE 10 2020 112 055 A1 discloses a method for acoustic vehicle staging. If it is detected that one or more users are approaching or moving away from a parked vehicle that belongs to one of the users, vehicle-specific and user-individual instrumental music is output via at least one exterior loudspeaker of the vehicle and/or a loudspeaker of a mobile terminal of the user.

Vehicle sounds that are not relevant to safety and are used primarily for emotionalization can be perceived as superfluous and/or irritating, however. Reasons for this may be an excessively simple trigger condition for outputting the sound, a lack of ability to react to ambient conditions and a lack of complexity of the function or of the sound experience. By way of example, ESD is applied only for absolute values of speed, gas pedal angle and vehicle load and therefore always follows the same sound projection along these variables. By way of example, a Welcome staging can be provided in the same location and at an exact form every time at every interval of time from when the driver's door is opened.

Against the background, there is a need to specify an improved method suitable for enriching the prior art relating to sounds. There is also a need for obtaining suitable adaptation of an output of sounds that are not relevant to safety.

### SUMMARY

One or more of the above-stated needs are features of at least some of the embodiments disclosed and claimed herein.

In one embodiment, a method for outputs an acoustic signal in an interior of a motor vehicle using an interior loudspeaker. The method comprises the steps of: determining the acoustic signal to be output; acquiring situation information relating to operating the motor vehicle; determining signal information relating to the acoustic signal; adapting the acoustic signal on the basis of the situation information and the signal information; and outputting the adapted acoustic signal via the interior loudspeaker.

Based on the method, it is possible to output a wide variety of sounds, or acoustic signals, in the interior of the motor vehicle and to adapt them in such a way that a user of the motor vehicle perceives the sounds as enrichment and neither as superfluous nor as irritating, in line with their actual intention. Ut has been recognized in this case that the adaptation can be improved if the acoustic signal conforms to being appropriate to the situation and multifaceted. Both can be accomplished through the addition of further information: to that end, the acoustic signal to be output is first determined, the situation information is acquired and the signal information is determined on the basis of the signal.

The situation information characterizes the situation that the motor vehicle and/or the user thereof is in and in which the acoustic signal is intended to be output.

The signal information characterizes the signal to be output and can reveal the multifacetedness and/or complexity of the signal.

The acoustic signal is then adapted on the basis of the situation information and the signal information in order to be able to take into consideration both the appropriateness to the situation and a characteristic, for example the multifacetedness of the signal. The adapted acoustic signal is output by the interior loudspeaker. In other words, the adaptation of the signal involves the signal itself being taken into consideration as well. By way of example, a rather rarely output and comparatively complex acoustic signal is perceived to be irritating and/or superfluous rather less and therefore requires less adaptation, for example, than a comparatively simple acoustic signal that output rather more frequently.

The situation information can be acquired via a vehicle bus. The situation information can therefore effectively be acquired as information that is available in the motor vehicle anyway. The situation information can thus comprise information relating to the motor vehicle. An in particular person-independent characterization of the situation is therefore possible. Alternatively or additionally, the situation information can be acquired via a user input interface. The situation information can therefore effectively be acquired via the user interface that the motor vehicle already comprises. The status information can thus comprise information relating to operating the motor vehicle and/or information relating to the user of the motor vehicle. A user-specific characterization of the situation is therefore possible.

The situation information can comprise one of the following pieces of information: location of the motor vehicle, time of day, time of the last journey with the motor vehicle, seat occupancy inside the motor vehicle, a key identification, pedal information and/or driving style information. The situation information can also comprise one of the following pieces of information: speed, load, torque, position of an entry key relative to the vehicle on approaching from outside, mood of a user, biological and/or medical constitution of a user and/or driving mode. Each of the aforementioned pieces of situation information can influence the perception of the acoustic signal and may therefore need to be taken into consideration for adapting the acoustic signal. The information that the situation information comprises can characterize the motor vehicle, operating the motor vehicle and/or one or more users of the motor vehicle, in order to permit the most effective adaptation of the acoustic signal possible. The situation information may be acquirable via a vehicle bus, a camera device and/or a user input interface.

The signal information may be dependent on a duration, a volume, an intensity, a localization of the signal in the interior, a number of repetitions and/or a cognitive content of the acoustic signal. The signal information can thus comprise information that effectively characterizes the acoustic signal. Said information can provide an indication of the perception of the acoustic signal and/or the complexity of the acoustic signal. The cognitive content of the acoustic signal may be meta-information associated with the acoustic signal, for example, and/or ascertainable in a computer-aided manner, in particular by using artificial intelligence.

The situation information can be acquired and the signal can be adapted while the signal is being output. It is therefore possible for a long signal, for example, to be able to be adapted to suit a situation during output. In other words, feedback can thus be obtained in order to be able to take into consideration an influence of the outputting of the acoustic signal on the situation, for example. To that end, the situation information is acquired while the acoustic signal is being output. The experience of the perception for a user can therefore be improved further.

The acoustic signal can be adapted on a user-specific basis. The acoustic signal to be output can thus be adapted to suit an identified user, or the character and/or mood of said user.

The situation information can be acquired via an on-vehicle camera device. The camera device can identify a user and/or the clothes of said user, for example, in order to reveal a situation. The situation information may thus be identification information for identifying the user.

In other words, and with reference to a specific arrangement described as being nonlimiting for the present disclosure, the description above can be summarized as follows: the essence of the disclosure is to adapt the sound and interaction of the output of an acoustic signal firstly according to appropriateness to the situation and secondly according to multifacetedness. Both can be accomplished in the arrangement through the addition of further vehicle information: in order to be able to present sounds in a manner appropriate to the situation, the time of use and the repetition, duration, form, intensity and location or direction of repetition of a sound are adapted on the basis of additional input variables. Information available in the motor vehicle such as location, time of day, time of the last journey, seat occupancy, key ID, etc., is used as such. To improve multifacetedness, the addition of further input variables, e.g. pedal gradients, driving style analysis, brake pedal status, permits new scopes of function that can permanently increase the pleasure in interacting with the vehicle.

Furthermore, a computer program comprising commands that, when the program is executed by a computer, cause said computer to perform, or carry out, at least part of the method described above is provided. By way of example, the computer is a data processing device, e.g. a control unit, for a motor vehicle.

A program code of the computer program can be available in any code, in particular in a code suitable for controllers of motor vehicles.

The description above with regard to the method also applies, mutatis mutandis, to the computer program, and vice versa.

Furthermore, a data processing device, e.g. a control unit, for a motor vehicle is provided, wherein the data processing device is configured to perform, or carry out, at least part of the method described above. The method is therefore a computer-implemented method.

The data processing device may be part of a driver assistance system or may be same. The data processing device may be an electronic control unit (ECU), for example. The electronic control unit may be an intelligent processor-controlled unit that can communicate with other modules e.g. via a central gateway (CGW), and that may possibly form the vehicle electrical system by way of field buses, such as the CAN bus, LIN bus, MOST bus and FlexRay, or by way of automotive Ethernet, e.g. together with telematics control units. The control unit may be an audio control unit of the motor vehicle that communicates with another control unit of the motor vehicle for example by way of a vehicle bus and/or by way of a local area network such as Ethernet. It is conceivable for the control unit and/or the other control unit to control functions relevant to the driving behavior of the motor vehicle, such as engine control, force transmission, the braking system and/or the tire pressure monitoring system. Moreover, driver assistance systems, for example a park assist system, adaptive cruise control (ACC), a lane departure warning system, a lane change assist system, a road sign recognition system, a traffic light detection system, a hill-start assist system, a night vision assist system and/or an intersection assist system, can be controlled by the control unit.

The description above with regard to the method and with regard to the computer program also applies, mutatis mutandis, to the data processing device, and vice versa.

Furthermore, a motor vehicle comprising the data processing device described above is provided.

The motor vehicle may be a passenger vehicle, in particular an automobile. The optionally automated motor vehicle may be designed to undertake longitudinal guidance and/or lateral guidance during automated driving of the motor vehicle, at least in part and/or at least intermittently. Automated driving can take place in such a way that the motor vehicle moves (largely) autonomously. Automated driving can be controlled at least in part and/or intermittently by the data processing device. The motor vehicle may be an autonomy level 0 to 5 motor vehicle.

The description above with regard to the method, with regard to the data processing device and with regard to the computer program also applies, mutatis mutandis, to the motor vehicle, and vice versa.

Furthermore, a computer-readable medium, in particular a computer-readable storage medium, is provided. The computer-readable medium comprises commands that, when the program is executed by a computer, cause said computer to perform at least part of the method described above.

That is to say that a computer-readable medium can be provided that comprises a computer program as defined above. The computer-readable medium may be any digital data storage unit, for example a USB stick, a hard disk, a CD-ROM, an SD card or an SSD card. The computer program does not necessarily have to be stored on such a computer-readable storage medium in order to be made available to the motor vehicle, but rather may also be obtained externally via the Internet or elsewhere.

The description above with regard to the method, with regard to the data processing device, with regard to the computer program and with regard to the automated motor vehicle also applies, mutatis mutandis, to the computer-readable medium, and vice versa.

### BRIEF DESCRIPTION OF THE DRAWINGS

FIG. 1 schematically shows a motor vehicle based on an aspect of the disclosure; and

FIG. 2 schematically shows a flowchart for a method based on an aspect of the disclosure.

### DETAILED DESCRIPTION

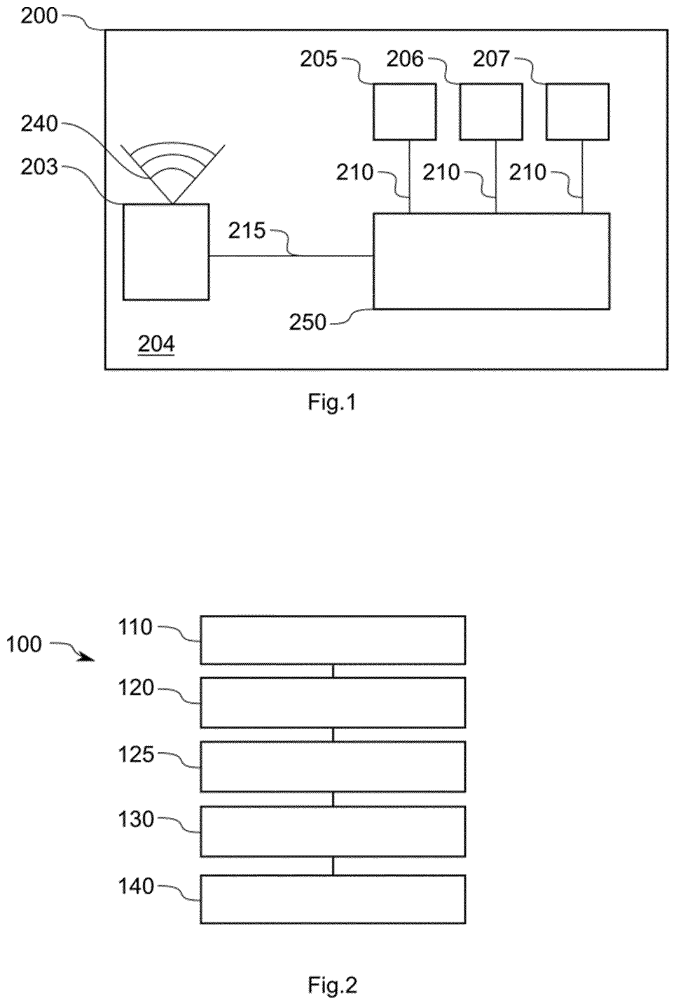

FIG. 1 schematically shows a motor vehicle 200 based on an aspect of the disclosure. The motor vehicle 200 is configured to carry out the method 100 described with reference to FIG. 2. To that end, the motor vehicle 200 has a data processing device 250 and an interior loudspeaker 203 disposed in an interior 204 of the motor vehicle 200.

The interior loudspeaker 203 is a device for outputting 140 an acoustic signal 240, the acoustic signal 240 being indicated schematically during a propagation in the interior 204. The interior loudspeaker 203 and the data processing device 250 are connected to one another so that the data processing device 250 can drive interior loudspeaker 203 to output 140 the acoustic signal 240.

In an embodiment that is not shown, the motor vehicle 200 comprises multiple interior loudspeakers 203 in order to be able to output one or more acoustic signals 240 in different areas of the interior 204 and/or with different orientations of the acoustic signals 240. It is therefore possible to localize the acoustic signal 240 differently, for example in order to produce a stereo sound.

The motor vehicle 200 shown in FIG. 1 has a vehicle bus 205, a user input interface 206 and a camera device 207. The vehicle bus 205, the user input interface 206 and the camera device 207 are each to the data processing device 250 in order to acquire situation information 210 and to relay it to the data processing device 250.

The vehicle bus 205 is a CAN bus, for example. The vehicle bus 205 is used to relay for example one of the following the situation information 210 to the data processing device 250: a location of the motor vehicle 200, a time of day, a time of a last journey with the motor vehicle 200 and/or a seat occupancy inside the motor vehicle 200.

The user input interface 206 comprises for example an interface for the user to provide input for an in-vehicle entertainment system, an interface for activating the motor vehicle 200, for example a closing apparatus of the motor vehicle 200, a pedal of the motor vehicle 200, a steering wheel of the motor 200 and/or another input interface. The user interface 210 is used for example to acquire a key identification, pedal information and/or driving style information as situation information 210 and to relay said situation information to the data processing device 250. The user input interface 210 can also comprise a microphone for acquiring acoustic inputs.

The camera device 207 is configured to acquire image information with respect to a user or driver in particular in the interior 204 of the motor vehicle 200. The camera device 207 is configured to process the image information and thus to identify the user, for example, and to create corresponding user information. Besides the identity of the user, the user information can also relate to information that indicates example a situation, a frame of mind and/or a basic emotion of the user. By way of example, the user information can comprise information relating to a clothing of the user. The user information can be relayed to the data processing device 250 as situation information 210.

The data processing device 250 is configured to determine the acoustic signal 240 to be output. By way of example, the acoustic signal 240 may be caused and/or initiated by a user input, entertainment device of the motor vehicle 200, a driver assistance function of the motor vehicle 200 and/or an automated driving function of the motor vehicle 200. The data processing device 250 can determine the acoustic signal 240 to be output accordingly. The acoustic signal 240 to be output is characterizable by signal information 215. The signal information 215 is for example dependent on a duration, a volume, an intensity, a localization of the signal 240 in the interior 204, a number of repetitions and/or a cognitive content of the acoustic signal 240.

The data processing device 250 is configured to adapt the acoustic signal 240 on the basis of the signal information 215 and the situation information 210. In particular, this can involve adapting a volume, a reproduction speed and/or a content of the acoustic signal 240. The acoustic signal 240 can be adapted 130 dynamically, i.e. the acoustic signal 240 can be adapted differently at different times on the basis of the signal information 215 and the situation information 210. By way of example, the acoustic signal 240 can be adapted in such a way that the volume is initially low and rises over the course of output of the acoustic signal 240. Output 140 of the acoustic signal 240 can also be dynamically adapted to the cognitive content of the acoustic signal 240.

The information relayed by the camera device 207, for example, allows the acoustic signal 240 to be adapted 130 on a user-specific basis. The acoustic signal 240 can therefore be adapted 130 in view of a preference of the user.

The adaptation 130 of the acoustic signal 240 is also described with reference to FIG. 2.

FIG. 2 schematically shows a flowchart for a method 100 based on an aspect of the disclosure. The method 100 is a method 100 for outputting 140 an acoustic signal 250 in an interior 205 of a motor vehicle 200. Such a motor vehicle 200 is described with reference to FIG. 1, to which reference is made hereinbelow.

The method 100 comprises determining 110 the acoustic signal 240 to be output. By way of example, the acoustic signal 240 is determined 110 on the basis of activation of the motor vehicle 200 and/or initiation of an entertainment function, a driver assistance function and/or an automated driving function.

Situation information 210 relating to operating the motor vehicle 200 is acquired 120. The information is acquired 120 via a vehicle bus 205, a user input interface 206 and/or a camera device 207.

Signal information 215 relating to the acoustic signal 240 is determined 125. The signal information 215 characterizes the acoustic signal 240. The signal information 215 can be determined on the basis of meta-data of the acoustic signal 240 and/or by analyzing the acoustic signal 240.

The acoustic signal 240 is adapted 130 on the basis of the situation information 210 and the signal information 215. The situation information 210 and the signal information 215 are evaluated together in order to adapt the acoustic signal 240. During the adaptation 130 it is borne in mind that the more complex an acoustic signal 240 is, the more rarely it can occur and/or the more intelligently it needs to be presented in order for the user to perceive it as enrichment. Frequently occurring acoustic signals 240 are typically kept very simple. In particular regularly occurring acoustic signals 240 directly linked to control actions, such as a “Welcome sound”, run the particular risk of being perceived as superfluous if suitable adaptation 130 does not take place.

The adapted acoustic signal 240 is output 140 via the interior loudspeaker 203. The situation information 210 can be acquired 120 and the signal 240 can be adapted 130 while the signal 240 is being output 140.

A person skilled in the art will recognize that the order of the steps of the method 100 can be varied and may be a different order than shown in FIG. 2. Steps of the method 100 can be carried out in a different order, simultaneously and/or on an ongoing basis. By way of example, it is possible both for the situation information 210 to be acquired 120 and for the signal information 215 to be determined 125 on an ongoing basis. The situation information 210 can be acquired 120 at any desired time. The acoustic signal 240 can be output 140 even before the signal information 215 is determined 125 and/or before the acoustic signal 240 is adapted 130.

The method 100 can be illustrated as follows on the basis of the two examples, which refer to one specific arrangement each and are described as nonlimiting for the present disclosure:

At 7 o'clock on Monday morning, a user unlocks the motor vehicle 200 and the motor vehicle 200 greets the user by way of an acoustic signal 240 in a friendly manner and quietly, so as not to disturb anyone. In the city in the afternoon, the level of staging increases: after the motor vehicle 200 is unlocked, the motor vehicle 200 outputs 140 an acoustic signal 240 in order to proffer a Welcome soundscape that can be reproduced in the direct vicinity of the motor vehicle 200 and/or the user. The acoustic signal 240 can be output 140 via an exterior loudspeaker that is fitted as standard, which is installed on an in particular electrically driveable motor vehicle to protect pedestrians. Opening a door of the motor vehicle 200 changes nothing about this at first, until the user sits in a seat in the interior 204—the soundscape moves inside with the driver and is finally terminated when the drive position D is engaged, that is to say as a result of a user input. If another user uses their own key identifier, KeyID, to open the motor vehicle 200, in an individual greeting is heard accordance with the key identifier. In the evening, at the “Home” point of interest, a “good night” signal 240 is heard when the driver gets out of the vehicle; on being locked, the vehicle uses a double tone to provide notification that it is still over 50% charged. In this example, the motor vehicle 200 appears to react to the situation instead of always proffering the same staging.

In a sports mode of the motor vehicle 200, an acoustic signal 240 is used to stage the start of a race. When the gas pedal and the brake are depressed simultaneously, sounds begin that e.g. give the impression that technical instances are being loaded. When the gas pedal is taken away, the sonic environment returns to the initial level. When the brake pedal is released, on the other hand, a boost sound comes in and emphasises the propulsion of the motor vehicle 200. Depending on a gas pedal gradient and the previously applied load, load shedding is staged. If the gas pedal angle rises quickly to 100% during the journey, sounds e.g. akin to an injection of laughing gas are heard. Besides the driving sound, the form and reproduction of alert tones or sound signals change. Instead of a flasher relay, e.g. a heartbeat is heard. Based on direction, the stereo image moves in the appropriate direction. Depending on driving style, the turn signal timing is overlaid with additional beats and the “pulse” is increased. In this example, the staging is extended by additional driving information and thus complexity and the opportunity for interaction are improved.

### LIST OF REFERENCE SIGNS

100 method
110 determine an acoustic signal
120 acquire
125 determine signal information
130 adapt
140 output
200 motor vehicle
203 interior loudspeaker
204 interior
205 vehicle bus
206 user input interface
207 camera device
210 situation information
215 signal information
240 acoustic signal
250 data processing device

1.-10. (canceled)

11. A method for outputting an acoustic signal in an interior of a motor vehicle using an interior loudspeaker, the method comprising:
determining the acoustic signal to be output;
acquiring situation information relating to operating the motor vehicle;
determining signal information relating to the acoustic signal;
adapting the acoustic signal based at least in part on the situation information and the signal information; and
outputting the adapted acoustic signal via the interior loudspeaker.

12. The method as claimed in claim 11, wherein acquiring the situation information comprises acquiring the situation information at least in part via a vehicle bus.

13. The method as claimed in claim 12, wherein the situation information comprises at least one of the group consisting of:
a location of the motor vehicle;
a time of day;
a time of the last journey with the motor vehicle;
a seat occupancy inside the motor vehicle;
a key identification;
pedal information; and
driving style information.

14. The method as claimed in claim 12, wherein acquiring the situation information comprises acquiring the situation information at least in part via an on-vehicle camera device.

15. The method as claimed in claim 11, wherein acquiring the situation information comprises acquiring the situation information at least in part via a user input interface.

16. The method as claimed in claim 11, wherein the situation information comprises at least one of the group consisting of:
a location of the motor vehicle;
a time of day;
a time of the last journey with the motor vehicle;
a seat occupancy inside the motor vehicle;
a key identification;
pedal information; and
driving style information.

17. The method as claimed in claim 16, wherein the signal information is dependent on at least one of the group consisting of:
a duration of the acoustic signal;
a volume of the acoustic signal;
an intensity of the acoustic signal;
a localization of the acoustic signal in the interior;
a number of repetitions of the acoustic signal; and
a cognitive content of the acoustic signal.

18. The method as claimed in claim 16, wherein the signal information is dependent on a frequency of repetition of the acoustic signal and a content of the acoustic signal.

19. The method as claimed in claim 11, wherein the signal information is dependent on a frequency of repetition of the acoustic signal and a content of the acoustic signal.

20. The method as claimed in claim 11, wherein the signal information is dependent on at least one of the group consisting of:
a duration of the acoustic signal;
a volume of the acoustic signal;
an intensity of the acoustic signal;
a localization of the acoustic signal in the interior;
a number of repetitions of the acoustic signal; and
a cognitive content of the acoustic signal.

21. The method as claimed in claim 11, wherein acquiring the situation information further comprises acquiring the situation information while the acoustic signal is being output.

22. The method as claimed in claim 21, wherein adapting the acoustic signal further comprises adapting the acoustic signal while the acoustic signal is being output.

23. The method as claimed in claim 11, adapting the acoustic signal further comprises adapting the acoustic signal on a user-specific basis.

24. The method as claimed in claim 11, wherein acquiring the situation information comprises acquiring the situation information at least in part via an on-vehicle camera device.

25. A non-transitory computer-readable medium comprising commands that, when executed by a computer, cause said computer to carry out the method as claimed in claim 11.

26. A data processing device for a motor vehicle, wherein the data processing device is configured to carry out the method as claimed in claim 11.

27. A motor vehicle comprising the data processing device as claimed in claim 26.
